(19) United States
(12) Patent Application Publication
(10) Pub. No.: US 2026/0077669 A1
(43) Pub. Date: Mar. 19, 2026

(54) VACATION MODE FOR RECHARGEABLE ENERGY STORAGE SYSTEM

(71) Applicant: GM GLOBAL TECHNOLOGY OPERATIONS LLC, Detroit, MI (US)

(72) Inventors: Ryan Christopher Mansfield, Madison Heights, MI (US); Balin Kumar Shrivastava, Ferndale, MI (US); Alec Rounds, Commerce Twp, MI (US); Adrian Liro, Ann Arbor, MI (US)

(73) Assignee: GM GLOBAL TECHNOLOGY OPERATIONS LLC, Detroit, MI (US)

(21) Appl. No.: 18/888,004

(22) Filed: Sep. 17, 2024

(51) Int. Cl. B60L 53/62; B60L 58/12; B60L 58/24

(52) U.S. Cl. CPC B60L 53/62; B60L 58/12; B60L 58/24; B60L 2250/00

(57) ABSTRACT

A vehicle, a system and a method for managing energy for a rechargeable energy storage system (RESS) are provided. The method includes identifying a desired state of charge (SOC) of the RESS at a return time; activating a vacation mode having a target SOC and target RESS temperature range, wherein the target SOC is less than the desired SOC; determining whether a current SOC is greater than the target SOC; when the current SOC is greater than the target SOC, consuming RESS energy for all energy demand; when the current SOC is less than the target SOC, consuming energy from a charger for all energy demand; determining whether a RESS temperature is outside the target RESS temperature range; and when the RESS temperature is outside the target RESS temperature range, performing a thermal condition process to change the RESS temperature to a temperature within the target RESS temperature range.

### INTRODUCTION

The technical field generally relates to rechargeable energy storage systems (“RESS”) and more particularly relates to methods and systems for state of charge (SOC) management and thermal management of rechargeable energy storage systems, such as in electric vehicles.

Rechargeable energy storage systems (RESS), including lithium-ion and related batteries, are increasingly being used in a variety of fields as a way to more efficiently generate, store, and distribute electrical power. In automotive applications, rechargeable energy storage systems are being used as a way to supplement, in the case of hybrid electric vehicles (HEVs), or supplant, in the case of purely electric vehicles (EVs), i.e., battery electric vehicles (BEVs), conventional internal combustion engines. The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms. In the present context, a cell is a single electrochemical unit, whereas a battery is made up of one or more cells joined in series, parallel or both, depending on desired output voltage and capacity.

Temperature is one of the most significant factors impacting both the performance and life of a battery. Environmental temperatures (such as those encountered during protracted periods of inactivity in cold or hot environments, or due to extended periods of operation and concomitant heat generation on hot days) or abuse conditions (such as the rapid charge/discharge, or internal/external shorts caused by the physical deformation, penetration, or manufacturing defects of the cells) can negatively impact the ability of the battery to operate correctly, and in severe cases can destroy the battery entirely. Side effects of prolonged exposure to high temperature may include premature aging and accelerated capacity fade, both of which are undesirable.

Accordingly, it is desirable to provide methods and systems for maintaining a RESS within a target temperature range during periods of inactivity while providing the RESS at a target SOC when desired. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for managing energy for a rechargeable energy storage system (RESS) includes identifying a desired state of charge (SOC) of the RESS at a return time; activating a vacation mode having a target SOC of the RESS and target RESS temperature range, wherein the target SOC is less than the desired SOC; determining whether a current SOC of the RESS is greater than the target SOC; when the current SOC is greater than the target SOC, consuming RESS energy for all energy demand; when the current SOC is less than the target SOC, consuming energy from a charger for all energy demand; determining whether a temperature of the RESS is outside the target RESS temperature range; and when the temperature of the RESS is outside the target RESS temperature range, performing a thermal condition process to change the temperature of the RESS to a temperature within the target RESS temperature range.

In certain embodiments, the method further includes calculating a start time necessary to charge the RESS to the desired SOC by the return time; de-activating the vacation mode at the start time; and charging the RESS to the desired SOC.

In certain embodiments, the method further includes receiving an input from a user identifying the desired SOC and the return time.

In certain embodiments, the method further includes determining the return time based on a location of a user.

In certain embodiments, the method further includes determining the target SOC and target RESS temperature range of the vacation mode based on predicted ambient conditions.

In certain embodiments, the method further includes determining a most efficient use of energy stored in the RESS and energy available from the charger.

In certain embodiments, the method further includes determining the target SOC and target RESS temperature range of the vacation mode based on battery life.

In certain embodiments, the method further includes transferring RESS energy to the charger when the current SOC is greater than the target SOC.

In another embodiment, a vehicle includes an electric propulsion system; a battery; and a controller operatively connected to the battery, wherein the controller is configured to monitor a current battery temperature after the vehicle is connected to an outside power source at a plug time; determine an outside air temperature; identify a desired state of charge (SOC) of the battery at a return time; activate a vacation mode having a target SOC of the battery and target battery temperature range, wherein the target SOC is less than the desired SOC; determine whether a current SOC of the battery is greater than the target SOC; when the current SOC is greater than the target SOC, consuming battery energy for all energy demand; when the current SOC is less than the target SOC, consuming energy from the outside power source for all energy demand; determine whether a temperature of the battery is outside the target battery temperature range; and when the temperature of the battery is outside the target battery temperature range, activate a thermal condition process to change the temperature of the battery to a temperature within the target battery temperature range.

In certain embodiments of the vehicle, the controller is configured to calculate a start time necessary to charge the battery to the desired SOC by the return time; de-activate the vacation mode at the start time; and charge the battery to the desired SOC.

In certain embodiments of the vehicle, the controller is configured to receive an input from a user identifying the desired SOC and the return time.

In certain embodiments of the vehicle, the controller is configured to determine the return time based on a location of a user.

In certain embodiments of the vehicle, the controller is configured to receive the location of the user from a mobile device carried by the user.

In certain embodiments of the vehicle, the controller is configured to determine the target SOC and target battery temperature range of the vacation mode based on predicted ambient conditions.

In certain embodiments of the vehicle, the controller is configured to determine a most efficient use of energy stored in the battery and energy available from the outside power source.

In certain embodiments of the vehicle, the controller is configured to determine the target SOC and target battery temperature range of the vacation mode based on battery life.

In certain embodiments of the vehicle, the controller is configured to transfer battery energy to the outside power source when the current SOC is greater than the target SOC.

In another embodiment, a system for managing energy is provided and includes a rechargeable energy storage system (RESS); and a controller operatively connected to the RESS, wherein the controller is configured to: monitor a current RESS temperature after the system is connected to an outside power source at a plug time; determine an outside air temperature; identify a desired state of charge (SOC) of the RESS at a return time; activate a vacation mode having a target SOC of the RESS and target RESS temperature range, wherein the target SOC is less than the desired SOC; determine whether a current SOC of the RESS is greater than the target SOC; when the current SOC is greater than the target SOC, consuming RESS energy for all energy demand; when the current SOC is less than the target SOC, consuming energy from the outside power source for all energy demand; determine whether a temperature of the RESS is outside the target RESS temperature range; and when the temperature of the RESS is outside the target RESS temperature range, activate a thermal condition process to change the temperature of the RESS to a temperature within the target RESS temperature range.

In certain embodiments of the system, the controller is configured to calculate a start time necessary to charge the RESS to the desired SOC by the return time; de-activate the vacation mode at the start time; and charge the RESS to the desired SOC.

In certain embodiments of the system, the controller is configured to receive an input from a user identifying the desired SOC and the return time or is configured to determine the return time based on a location of a user.

### DESCRIPTION OF THE DRAWINGS

The present disclosure will hereinafter be described in conjunction with the following drawing figures, wherein like numerals denote like elements, and wherein:

FIG. 1 is a schematic environmental view of a motor vehicle having an electric propulsion system, such as a hybrid electric vehicle or battery electric vehicle, in accordance with some embodiments.

FIG. 2 is a schematic system diagram depicting a thermal management system for a motor vehicle, such as that shown in FIG. 1, in accordance with some embodiments.

FIG. 3 is a schematic first valve diagram depicting opening and closing states for a plurality of valves within a thermal management system, such as that shown in FIG. 2, in accordance with some embodiments.

FIG. 4 is a schematic second valve diagram depicting opening and closing states for a valve within a thermal management system, such as that shown in FIG. 2, in accordance with some embodiments.

FIG. 5 is a flowchart illustrating a method for determining vacation mode performance guidelines such as an ideal storage SOC and an ideal storage battery temperature or temperature range, in accordance with some embodiments.

FIG. 6 is a flowchart illustrating a method for operating a device according to a vacation mode to optimize efficient use of energy, battery health, and battery life, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

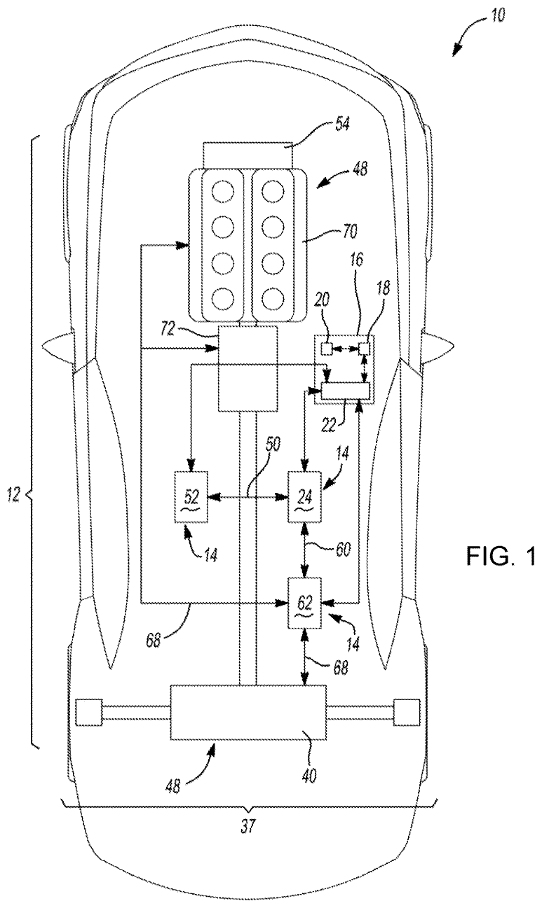

Referring to the drawings, like reference numbers refer to similar components, wherever possible. FIG. 1 schematically illustrates a top view of a device 10 powered by electricity. In FIG. 1, the device 10 is a motor vehicle 10. While the vehicle 10 is depicted as a car, it should be understood that the vehicle 10 may be a car, a truck, an SUV, a van, a semi, a tractor, a bus, a go-kart, or any other rolling platform without departing from the scope or intent of the present disclosure. The vehicle 10 is equipped with a thermal management system 12.

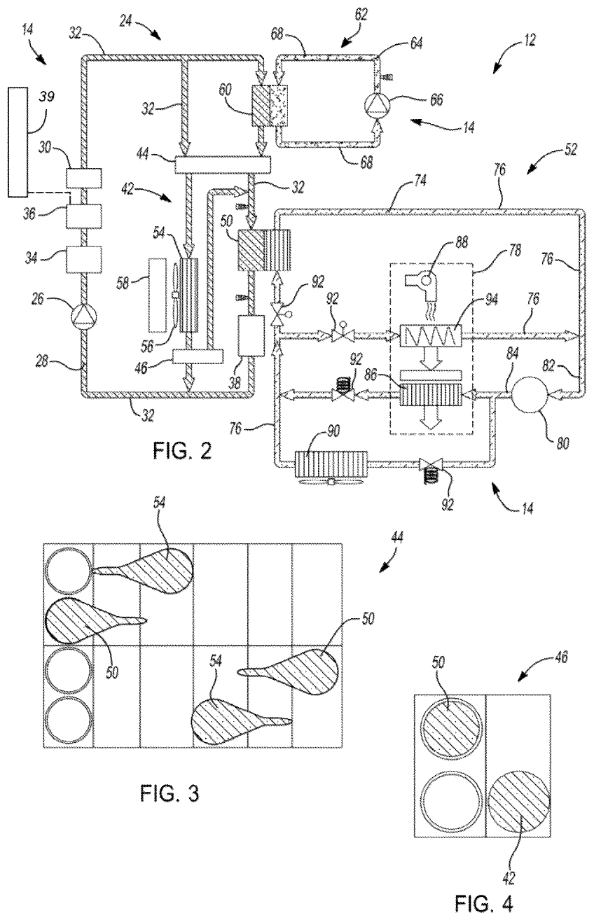

Referring also to FIG. 2, there is shown a schematic diagram of the thermal management system 12. In broad terms, the thermal management system 12 operates to selectively transport thermal energy from a heat source within the thermal management system 12 to a heat sink in the thermal management system 12, or from a heat source or a heat sink to a location within the thermal management system 12 where the thermal energy may be needed or used to improve function of the vehicle 10.

The thermal management system 12 includes a plurality of dissimilar thermal fluid loops 14 for various vehicle 10 sub-systems. Each of the dissimilar thermal fluid loops 14 has heat sources and heat sinks associated with one or more sub-systems of the vehicle 10. Some heat sinks are significantly more massive, and therefore, capable of storing more thermal energy, than other heat sinks. Accordingly, depending on the thermal energy storage capacities of various heat sinks within the thermal management system 12, thermal energy may be moved from one of the dissimilar thermal fluid loops 14 to another.

While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

As used herein, all state of charge (SOC) measurements are provided as a percentage of a total possible SOC of the battery.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

When used herein, the term “substantially” refers to relationships that are, ideally perfect or complete, but where manufacturing realties prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

The vehicle 10 may circulate or transfer thermal energy via a reduced number of thermal fluid loops 14 in comparison to other approaches. In the example illustrated in FIGS. 1 and 2, the vehicle 10 circulates thermal energy generated onboard the vehicle only via the three fluid loops 14. In other words, the thermal requirements for the vehicle 10, i.e., any needs for heating or cooling of vehicle 10 components, as well as heating or cooling of the passenger compartment, may be met using only the three thermal fluid loops 14. Thermal energy may be transferred via the thermal fluid loops 14 by way of conduction, convection, or any other heat transfer mechanism. As used herein, cooling refers to reducing the current temperature of the referenced component or system, and heating refers to increasing the temperature of the referenced component or system.

A control system or controller 16 is in communication with a plurality of actuators, valves, and the like, and manages the operation of the thermal management system 12, including the plurality of dissimilar thermal fluid loops 14. The controller 16 is a non-generalized, electronic control device having a preprogrammed digital computer or processor 18, a memory or non-transitory computer readable medium 20 used to store data such as control logic, instructions, lookup tables, etc., and a plurality of input/output peripherals or ports 22. The processor 18 is configured to execute the control logic or instructions described herein.

The controller 16 may have additional processors or additional integrated circuits in communication with the processor 18 such as logic circuits for analyzing thermal management data. In some examples, the controller 16 may be a plurality of controllers 16, each of which is designed to interface with and manage specific componentry within the vehicle 10, and each of the plurality of controllers 16 is in electronic communication with the others. However, while in some examples more than one controller 16 may be used, for ease of understanding, the following description will describe the thermal management system 12 as having only one controller 16. The controller 16 may be dedicated to the thermal management system 12 or may be part of a larger control system or other functions of the vehicle 10.

Referring to both FIGS. 1 and 2, a first of the dissimilar thermal fluid loops 14 is a coolant loop 24. The coolant loop 24 includes a coolant pump 26 selectively pumping coolant 28 through a plurality of coolant conduits 32. The coolant conduits 32 are in fluid communication with a variety of components of the coolant loop 24. In some aspects, the coolant loop 24 includes an integrated power electronics (IPE) module 34. The IPE 34 is an electronic device having a variety of accessories usable by an operator of the vehicle 10.

In some instances, the IPE 34 includes one or more of an AC/DC converter (not shown), a high voltage supply (not shown), a navigation system (not shown), a high voltage charger (not shown), a heated seat system (not shown), and/or other like devices and features. As the IPE 34 is operated, the electronics within the IPE 34 convert electrical energy into a variety of functions usable by the operator. In addition, thermal energy is generated as a byproduct of using electrical energy within the IPE 34 devices. The coolant 28 carries the thermal energy from the IPE 34 devices elsewhere in the coolant loop 24.

The coolant loop 24 further includes an onboard charging module (OBCM) 36 for a battery 38 of rechargeable energy storage system (RESS). The OBCM 36 is an electrical device designed to move energy into a secondary cell or rechargeable battery 38 by forcing an electrical current through the battery 38. In some examples, a single-phase 3.5 kW to 22 kW OBCM 36 is installed within the electrical system of the vehicle 10 and charges the vehicle 10 and the battery 38 from an outside power source 39.

The outside power source 39 may be, for example and without limitation, a connection to a power grid, to a generation device (such as a gas generator), a storage battery (such as those used with solar or wind power systems), or other power supply delivering electric energy to the vehicle 10. Depending on the outside power source 39, the amount of time needed to charge the battery 38 may vary. For example, fast chargers may be able to fully charge the battery 38 in less than one hour, while chargers working off of standard home (110 volt or 240 volt) wiring may take longer.

In some configurations of the vehicle 10, the battery 38 can be used as an energy source, and therefore, the OBCM 36 can also direct electrical energy to the electrical grid, or to accessory or ancillary devices within the vehicle 10. In addition, the OBCM 36 can also direct electrical energy to devices, such as cellular phones, and the like that an operator of the vehicle 10 may power from electrical connections within the IPE 34 of the vehicle 10.

Therefore, the OBCM 36 may be a bi-directional battery charging and discharging device. In many instances, the battery 38 is most efficiently charged when the battery 38 is heated to a predetermined target temperature. In one aspect, the predetermined target temperature is approximately 25° Celsius. However, depending on the componentry and the thermal requirements of the thermal management system 12, the predetermined target temperature of the battery 38 may vary. In one example, to achieve the target temperature range, the battery 38 can be heated electrically via electrical energy supplied by the OBCM 36. In that example, the controller 16 effectively overdrives the OBCM 36 or drives the OBCM 36 in a calculatedly inefficient manner, such as off-phasing, so as to convert a predetermined amount of electrical energy from the outside power source 39 into thermal energy, e.g., to raise the temperature of the battery 38.

In another example, the battery 38 itself is charged in a calculatedly inefficient manner. That is, the battery 38 is charged inefficiently so that a portion of the electrical energy being driven into the battery 38 by the OBCM 36 is converted into thermal energy, which is then stored within the mass of the battery 38 while the battery 38 is being charged. In yet another example, thermal energy is directed to the battery 38 via coolant 28 carried by the coolant loop 24 from other heat sources within and external to the coolant loop 24. The coolant loop 24 may include a coolant heater 30. The coolant heater 30 is an electrically powered heater, such as a resistive heater, that adds thermal energy to the flow of coolant 28. In some examples, once the battery 38 has been electrically charged sufficiently, the temperature of the battery 38 is regulated by the OBCM 36.

In configurations, the vehicle 10 includes a braking system 37 having a regeneration function. In vehicles 10 having regenerative braking systems, an electric motor 40 is used as an electric generator. Electricity generated by the electric motor 40 is fed back into the battery 38 by the OBCM 36. In some battery electric and hybrid vehicles, the energy is also stored in a bank of capacitors (not shown), or mechanically in a rotating flywheel (not shown). Under circumstances when the controller 16 and OBCM 36 determine that the battery 38 is fully charged or additional heating is otherwise desired, the electricity generated by the electric motor 40 can be converted into thermal energy and stored in the mass of the battery 38, other components of the thermal management system 12, or may be dissipated to the ambient air by the thermal management system 12.

Referring also to FIGS. 3 and 4, and with continuing reference to FIGS. 1 and 2, there are shown additional views of components of the thermal management system 12. To maintain control over the temperature of the battery 38, in some examples, the coolant loop 24 includes a battery bypass 42. In general terms, the battery bypass 42 is operable to selectively provide flow of the coolant 28 through the battery 38 or to bypass the battery 38 under a predetermined set of conditions. For example, the battery bypass 42 is set in a closed position when a temperature of the battery 38 is below the preferred temperature of the battery 38. In such an example, the coolant 28 flows through the battery 38 and imparts thermal energy to the battery 38 from the OBCM 36, the coolant heater 30, and other components of the thermal management system 12.

In another example, the battery bypass 42 is set in an open position when the battery temperature is above the optimal battery 38 temperature. In the second example, coolant 28 flow is directed away from the battery 38. The controller 16 manages or directs the flow of coolant 28 through the battery bypass 42 by way of at least a first bypass valve 44 and a second bypass valve 46. The first bypass valve 44 operates to selectively direct the flow of coolant 28 past a second of the dissimilar thermal fluid loops 14, namely around a drive unit 48 disposed in a drive unit oil loop 62. The drive unit 48 provides torque to move the vehicle 10. The second bypass valve 46 operates to selectively direct the flow of coolant 28 around a third of the dissimilar thermal fluid loops 14, namely around a chiller 50 of a refrigerant loop 52. Depending on the requirements of the thermal management system 12, the first bypass valve 44 and the second bypass valve 46 may be variable force solenoids (VFS) or valves, variable bleed solenoids (VBS) or valves, or binary or mode control solenoids or valves, merely as examples.

In the example of FIG. 3, the first bypass valve 44 is of the VFS or VBS type. Thus, the first bypass valve 44 is configured to be varied along a continuous spectrum between a fully closed state and opened state. In the fully closed state, the first bypass valve 44 prevents all coolant 28 flow incident upon an inlet of the first bypass valve 44 from flowing through the first bypass valve 44 to an outlet of the first bypass valve 44. By contrast, in the fully opened state, the first bypass valve 44 will provide all coolant 28 flow incident upon the inlet of the first bypass valve 44 to the outlet of the first bypass valve 44. The first bypass valve 44 should be understood to vary the valve opening in accordance with the coolant 28 flow demands of the thermal management system 12.

In FIG. 3, and with reference to FIG. 2, the upper half of the valve diagram depicts a situation in which the drive unit 48 is receiving thermal energy from the coolant 28 via a heat exchange device, such as a transmission oil cooler (TOC) 60. The upper half of the valve diagram shows that the first bypass valve 44 is providing a variable amount of flow through a radiator 54 and the chiller 50 while also providing coolant 28 to the TOC 60. In the bottom half of the valve diagram in FIG. 3, the valve diagram shows a situation in which the first bypass valve 44 is shunting coolant 28 away from the TOC 60, thereby bypassing heat exchange with the drive unit oil loop 62 entirely. However, the first bypass valve 44 still provides variable flow through the radiator 54 and the chiller 50.

In the example of FIG. 4, and with continued reference to FIGS. 1 and 2, the second bypass valve 46 is of the binary or mode control variety. That is, the second bypass valve 46 is a binary valve having only fully open and fully closed states. In the fully closed state, the second bypass valve 46 prevents all coolant 28 flow incident upon an inlet of the second bypass valve 46 from flowing through an outlet of the second bypass valve 46. By contrast, in the fully opened state, the second bypass valve 46 will provide all coolant 28 flow incident upon the inlet of the second bypass valve 46 to the outlet of the second bypass valve 46.

The second bypass valve 46 should be understood to operate in open or closed states in accordance with the coolant 28 flow demands of the thermal management system 12, as directed by the controller 16. In the upper half of the valve diagram of FIG. 4, the second bypass valve 46 of FIG. 4 is depicted in a closed state in which coolant 28 flow is provided to the chiller 50. In the bottom half of the valve diagram of FIG. 4, in the open state, the second bypass valve 46 directs coolant 28 to bypass the chiller 50 and the battery 38 as well, thereby forming part of the battery bypass 42. Thus, when the second bypass valve 46 is open, coolant 28 flows from the second bypass valve 46 directly into the coolant conduits 32 leading to the coolant pump 26.

In some configurations, the first bypass valve 44 and second bypass valve 46 selectively direct the flow of coolant 28 through the radiator 54. The radiator 54 exchanges thermal energy between the coolant 28 and the atmosphere external to the vehicle 10. Thus, when the radiator 54 is used, thermal energy is rejected from the vehicle 10. In some configurations, the radiator 54 operates in conjunction with a fan 56 and an airflow management device, such as a shutter mechanism 58 operable to precisely regulate the temperature of the radiator 54 and, therefore, the coolant 28 passing through the radiator 54.

In some configurations, the shutter mechanism 58 is a series of vanes or flaps disposed in an orifice (not shown) on an exterior surface of the vehicle 10, such as a front, side, underside or top-side-facing air intake (not shown), or an intake disposed within a foglamp housing (not shown), or the like. The vanes or flaps of the shutter mechanism 58 are moved through a range of motion that provides at least an open position and a closed position. In several aspects, the controller 16 can variably alter the position of the shutter mechanism 58 electromechanically by way of solenoids, motors, actuators, and the like, hydraulically, by aerodynamic forces, or any combination of the above. In the open position, airflow incident upon the shutter mechanism 58 is allowed to pass through the shutter mechanism 58 toward the radiator 54 and/or the fan 56. In the closed position, airflow incident upon the shutter mechanism 58 is prevented from passing through to the radiator 54 and/or the fan 56.

While shutter mechanism 58 has been described herein as having open and closed positions, it should be understood that the shutter mechanism 58 may be manipulated variably into any position between fully open and fully closed as well. Thus, the controller 16 can manipulate the shutter mechanism 58 precisely to provide and modulate airflow to the radiator 54 when such airflow is desirable, and to prevent such airflow when no airflow is needed. In some examples, the controller 16 commands the shutter mechanism 58 to remain closed under a wide range of drive cycle conditions, thereby minimizing thermal energy rejection to the atmosphere via the radiator 54.

In further examples, the first bypass valve 44 and second bypass valve 46 variably direct the flow of coolant 28 through both the battery 38 and the radiator 54, as illustrated in FIG. 3, thereby providing the coolant loop 24 with the ability to precisely thermoregulate the battery 38 and other components within the coolant loop 24.

The first bypass valve 44 selectively directs flow of the coolant 28 through the battery 38 and/or through the TOC 60 disposed in the second of the dissimilar thermal fluid loops 14, namely, the drive unit oil loop 62. The TOC 60 is a heat exchange device providing a means of thermal energy transfer between the coolant loop 24 and the drive unit oil loop 62. The TOC 60 includes at least two passageways physically separated from one another. That is, on a first side of the TOC 60, a coolant 28 passageway (not shown) carries coolant 28 through the TOC 60 as a part of the coolant loop 24. On a second side of the TOC 60, an oil passageway (not shown) carries oil 64 through the TOC 60 as a part of the drive unit oil loop 62. However, it should be understood that despite the fact that the TOC 60 includes both a portion of the coolant loop 24 and the oil loop 62, there is no fluid interface between coolant 28 and oil 64 within the TOC 60, and thus the coolant 28 and oil 64 are prevented from mixing.

An oil pump 66 pumps the lubricating oil 64 through a plurality of oil conduits 68 in fluid communication with the drive unit 48. The drive unit 48 is a plurality of mechanical devices that convert chemical or electrical energy into torque to motivate the vehicle 10.

In some configurations, the mechanical devices include an engine 70 and a transmission 72. The engine 70 may be an internal combustion engine (ICE), an electric motor 40, and/or any other type of prime mover without departing from the scope or intent of the present disclosure. In some aspects, the engine 70 operates in conjunction with, or may be replaced entirely by at least one electric motor 40. The engine 70 and/or the electric motor 40 provide torque that moves the vehicle 10 via the transmission 72.

The transmission 72 may be a manual, automatic, multi-clutch, or continuously variable transmission, or any other type of electronically, pneumatically, and/or hydraulically-controlled automotive transmission 72 without departing from the scope or intent of the present disclosure. The transmission 72 is mechanically and/or fluidly coupled to the engine 70. The drive unit oil loop 62 circulates the oil 64 throughout the transmission 72, thereby keeping the internal components of the transmission 72 lubricated. In some aspects, the transmission 72 and the engine 70 share a supply of oil 64 via the oil loop 62. Moreover, in some examples, the circulating oil 64 is used to heat or warm the transmission 72 during startup of the engine 70 or to cool the transmission 72 as necessary during heavy use.

The drive unit 48 has a predetermined optimal operating temperature at which the lubricating oil 64 has desirable viscosity and lubrication characteristics. In several aspects, the predetermined optimal operating temperature is approximately 70° Celsius. However, depending on the application and the components of the drive unit 48 and in the drive unit oil loop 62, the optimal operating temperature may vary substantially. For example, in drive units 48 having an internal combustion engine 70, the optimal oil 64 temperature circulating through the engine 70 is between about 85° Celsius and about 120° Celsius. In another example, in drive units 48 having an automatic transmission 72, the optimal temperature of the oil 64 circulating through the automatic transmission 72 may be between about 20° Celsius and about 110° Celsius. In still another example, in drive units 48 having an automatic transmission 72 coupled to a torque converter (not shown), the temperature of oil 64 circulating through the torque converter may be between about 90° and about 180° Celsius.

Referring once more to FIG. 4 and with continuing reference to FIGS. 1-3, the second bypass valve 46 selectively directs flow of the coolant 28 through the battery 38 and/or through the chiller 50 disposed in the third of the dissimilar thermal fluid loops 14, in particular, the refrigerant loop 52. The chiller 50 is a heat exchange device providing a means of thermal energy transfer between the coolant loop 24 and the refrigerant loop 52. However, like the TOC 60, the chiller 50 includes at least two passageways physically separated from one another. That is, on a first side of the chiller 50, a coolant 28 passageway (not shown) carries coolant 28 through the chiller 50 as a part of the coolant loop 24. On a second side of the chiller 50, a refrigerant passageway (not shown) carries a refrigerant 74 through the chiller 50 as a part of the refrigerant loop 52. However, it should be understood that despite the fact that the chiller 50 includes both a portion of the coolant loop 24 and the refrigerant loop 52, there is no fluid interface between coolant 28 and refrigerant 74 within the chiller 50, and thus the coolant 28 and refrigerant 74 are prevented from mixing.

The refrigerant loop 52 includes a plurality of refrigerant conduits 76 fluidly connecting a plurality of devices operable to thermally regulate a passenger compartment (not specifically shown) contained within the vehicle 10. The passenger compartment may be thermally isolated from other vehicle components generating heat, and may receive flows of thermal energy via one or more vents or other conduits (not specifically shown) of a heating, ventilation, and air conditioning (HVAC) system 78. The refrigerant loop 52 also carries thermal energy to and from the coolant loop 24 via the chiller 50. The refrigerant loop 52 includes a variety of operator comfort systems such as the HVAC system 78.

Fundamentally, the refrigerant loop 52 has a heating function and a cooling function. Within the refrigerant loop 52, the HVAC system 78 provides heated and/or cooled air to a passenger compartment of the vehicle 10. Stated another way, the HVAC system 78 transports thermal energy from a cooler location to a warmer location within the refrigerant loop 52. In several aspects, the HVAC system 78 functions as a heat pump. That is, the HVAC system 78 is an air conditioner in which both heating and cooling functions are possible.

In one example, the operator of the vehicle 10 determines a desired passenger compartment air temperature and selects a heating cycle for the HVAC system 78. The HVAC system 78 includes a compressor 80. The refrigerant 74 enters the compressor 80 via the refrigerant conduit 76, which may be known as a suction line 82. The compressor 80 compresses gaseous refrigerant 74, thereby increasing the temperature and pressure of the refrigerant 74. The now high-pressure, high-temperature refrigerant 74 then leaves the compressor 80 via a refrigerant conduit 76 known as a discharge line 84 and flows into a cabin condenser 86. In some aspects, the cabin condenser 86 is a heat exchange device having a plurality of condenser coils through which the refrigerant 74 flows. The coils are in contact with the passenger compartment atmosphere. An HVAC blower or fan 88 blows air over the cabin condenser 86, thereby releasing thermal energy from the condenser 86 into the passenger compartment atmosphere. In some aspects, the refrigerant loop 52 includes a second or exterior condenser 90. The exterior condenser 90 is in contact with the ambient atmosphere external to the vehicle 10 and when engaged, releases thermal energy from the refrigerant 74 from the vehicle 10 to the atmosphere.

The HVAC system 78 further includes a plurality of expansion valves 92. Depending on the HVAC system 78 design parameters or characteristics, the expansion valves 92 may be mechanical thermostatic expansion valves (TXV) (not specifically shown) and/or electronic expansion valves (EXV) (not specifically shown). Control over the rate of refrigerant 74 expansion may be more directly and precisely controlled with EXVs than with TXVs, however in some cases it is desirable to use TXVs for reasons of cost, simplicity, and the like. Condensed, pressurized, and still somewhat warm refrigerant 74 received from the cabin condenser 86 and/or exterior condenser 90 is routed through an expansion valve 92. As the refrigerant 74 is de-pressurized by the expansion valve 92, the refrigerant 74 cools. The refrigerant 74 then passes through an evaporator 94. The evaporator 94 is a heat exchange device in which a series of refrigerator coils (not shown) carry a flow of cooled refrigerant 74.

The refrigerator coils exchange thermal energy with the passenger compartment atmosphere. The HVAC blower or fan 88 blows air over the cabin evaporator 94 thereby cooling the passenger compartment of the vehicle 10. The refrigerant 74, having passed through the evaporator 94 is then directed back through the compressor 80. Refrigerant 74 is also selectively passed through an expansion valve 92 to the chiller 50, where thermal energy is either obtained from or released to the coolant loop 24, depending on the relative temperatures of the coolant 28 and the refrigerant 74, and the thermal requirements of the battery 38 and other thermal management system 12 componentry.

In some configurations, the HVAC system 78 can be operated intermittently or continuously by occupants in the passenger compartment, or by the controller 16 depending on optimal heating and/or cooling requirements of the passenger compartment, or optimal heating and/or cooling requirements of other components of the thermal management system 12. The HVAC system 78 may operate continuously as a heat pump. As previously discussed, while operating as a heat pump, the HVAC system 78 directs refrigerant 74 through the cabin condenser 86, thereby rejecting the thermal energy in the refrigerant 74 to the passenger compartment and cooling the refrigerant 74. However, because the refrigerant loop 52 exchanges thermal energy with the coolant loop 24 in the chiller 50, a temperature of the refrigerant 74 in the refrigerant loop 52 remains substantially above the freezing point of water. That is, the refrigerant 74 continuously exchanges thermal energy with the coolant 28, and with the oil 64 in the oil loop 62 via the coolant 28 in the coolant loop 24.

Therefore, while refrigerant 74 is passing through the cabin condenser 86 and the exterior condenser 90 rejects thermal energy, and is cooled, thermal energy is also obtained as the refrigerant 74 passes through the chiller 50. Thus, because the temperature of the refrigerant 74 remains substantially above the freezing point of water, the cabin condenser 86 remains substantially free of ice accumulation. Similarly, in a second example, the controller 16 directs refrigerant 74 through the exterior condenser 90 where the refrigerant 74 is cooled by rejecting thermal energy to the atmosphere, but because the refrigerant 74 also flows through the chiller 50, a temperature of the refrigerant 74 remains substantially above the freezing point of water.

Therefore, in both the first and second examples, ice is prevented from forming on both the cabin condenser 86 and exterior condenser 90 even if one, the other, or both the cabin condenser 86 and exterior condenser 90 are used continuously. Moreover, even if ice does begin to accumulate on the cabin condenser 86 or exterior condenser 90, the controller 16 directs thermal energy from one of the thermal energy reservoirs in the oil loop 62 or the coolant loop 24 to the chiller 50, and using the expansion valves 92, through the cabin condenser 86 and/or exterior condenser 90, thereby melting any accumulation of ice as needed.

While FIG. 1 illustrates electric device 10 in the form of a motor vehicle 10, device 10 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the device 10 may instead be part of and/or coupled to any number of other types of platforms and/or other systems, moving or non-moving, such as a building, infrastructure, secondary use, home power, non-automotive, and/or other platforms and/or other systems powered by electricity.

Embodiments herein are provided in which the controller 16, in conjunction with the processor 18, memory or non-transitory computer readable medium 20, and input/output peripherals or ports 22, activates a vacation mode during extended periods of non-use that optimizes energy use and battery life, while maintaining the health of the battery 38 of the RESS. Specifically, the controller 16 optimizes use of energy stored in the battery 38 and energy provided from the outside power source 39. The controller 16 may de-activate vacation mode and charge the battery to a desired state of charge (SOC) so that the device 10 is ready for use when the user returns.

Vacation mode may be used when energy from the battery 38 is not needed to power the device 10 for an extended period of time. In certain embodiments, the extended period of time may be at least one day, at least three days, at least five days, at least a week, or longer.

A user may input a command through an input/output port 22 that notifies the controller 16 that energy from the battery 38 will not be needed to power the device 10 for an extended period of time. For example, the user may be at the device 10 and enter the input through a hardware interface of the device or through a local communication system such as from a mobile phone. Alternatively, the user may be away from the device 10 and may enter the input through computer terminal or other communication device, such as a mobile phone, that may communicate with the controller 16. In other embodiments, the controller 16 itself may determine that the battery 38 will not be needed to power the device 10 for an extended period of time. For example, geofencing may be used by creating a virtual boundary around a specific geographic area using GPS, RFID, Wi-Fi, or cellular data; tracking movement of the user and/or movement of the device continuously using GPS or other tracking technologies; analyzing usage patterns to identify periods when the vehicle remains within the geofence or is not used for extended periods; and use historical data and patterns to predict future behavior.

In one example, a user parks an electric vehicle 10 at a first airport and flies to a second airport. The controller 16 may determine that the vehicle 10 will not be needed for a sufficient period of time to begin vacation mode based on the location of the user. Further, when geofencing determines that the user has returned to the second airport in order to return to the first airport, the controller 16 may de-activate vacation mode and begin charging the battery to a desired state of charge (SOC).

Certain embodiments provide more efficient long-term EV/PHEV storage. The efficiency gain is seen in terms of energy consumption and consequently cost, as well as warranty cost by decreasing part cycling and battery cell aging. Certain embodiments achieve peak efficiency by constantly evaluating the energy needed by the system to reach a modeled future time, and adjusting charging priority to meet the user desired SOC.

In certain embodiments, the battery SOC is decreased from an initial SOC to a lower point to decrease effects of calendar aging of the battery. Certain embodiments decrease the cost and energy consumed from outside source charging station. Certain embodiments utilize more aggressive thermal targets (both high and low) due to the long time vacation, rather than more typical short-term non-sue periods of several hours.

In certain embodiments, a controller operates according to an algorithm, having a variety of inputs and a logic map, and in which the start time of charging to a target SOC is determined based on the grid-side capability and the predicted electrical energy and thermal energy needed to complete a desired task for the device. In certain embodiments, the algorithm estimates the amount of thermal energy required to achieve a desired state based on ambient conditions, station capability, and device status. In certain embodiments, the algorithm estimates the amount of electrical energy required to achieve a desired state based on ambient conditions, station capability, and device status. Certain embodiments include a consideration factor for reducing cycling of components within the device to increase lifespan of the component and reduce warranty cost, i.e., minimize thermal mitigation actions. Certain embodiments include a consideration factor of battery cell life to adjust the hold state of charge at a point which reduces aging factors. In certain embodiments, the algorithm determines start and end conditions based on geofencing of the device, geofencing of the user, user input, connected app input, and other inputs. In certain embodiments, the algorithm seeks to minimize energy usage by modifying thermal targets. In certain embodiments, the algorithm reduces energy consumption for an untethered vehicle by targeting more aggressive thermal targets. In this case, energy consumption and cost are reduced over a vacation period of non-use. In certain embodiments, the algorithm displays to the user the amount of energy and money saved by operation in vacation mode.

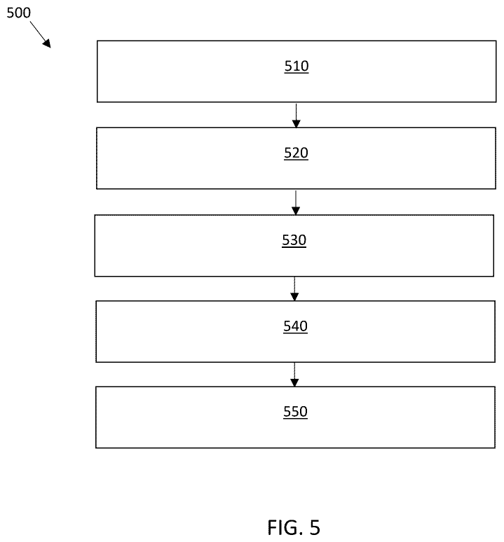

FIG. 5 illustrates a method 500 for the controller 16 to determine vacation mode performance guidelines. As shown, method 500 includes, at action block 510, determining ambient conditions such as air temperature and/or sun power at the location of the device 10 during the vacation period. In certain embodiments, sensors at the device 10 determine the current ambient temperature and determine the amount of heat received from solar energy at the device location and use recorded data to predict future thermal inputs. In certain embodiments, the controller 16 may obtain predicted weather conditions including ambient temperature and/or solar power. Further, the ambient conditions may be determined or predicted at defined intervals to determine times of the day at which battery temperature may be most affected by the ambient conditions.

Ambient conditions may also include the initial state of charge (SOC) of the battery 38.

Method 500 further includes, at action block 520, determining the effects of the ambient conditions on the temperature of the battery. For example, a predicted ambient temperature and a predicted solar energy over a period of time may be converted to an anticipated rise in battery temperature during a mid-day period, while a predicted overnight low temperature may be converted to an anticipated drop in battery temperature overnight.

At action block 530, the method 500 includes estimating the amount of energy needed for thermal conditioning during the vacation period. Specifically, the controller 16 calculates the amount of energy needed to operate the thermal management system 12 to keep the battery in a desirable or safe temperature range based on the predicted effects of the ambient conditions on the temperature of the battery. The thermal management system 12 may be needed to cool the battery 38 during hottest ambient conditions and/or to heat the battery 38 during coldest ambient conditions.

It is noted that the desirable or safe temperature range of the battery 38 is dependent on the state of charge (SOC) of the battery 38. Generally, the lower the SOC of the battery 38 is, the wider the safe temperature range is. Thus, action block 530 estimates the amount of energy needed for thermal conditioning during the vacation period over a range of states of charge (SOCs). Further, action block 530 may estimate the amount of energy needed for thermal conditioning during the vacation period over a variable range of states of charge (SOCs). Specifically, the controller 16 may determine that battery health or battery life may benefit from a different SOC during highest thermal conditions when battery cooling may be needed as compared to lowest thermal conditions when battery heating may be needed.

At action block 540, the method 500 includes estimating the amount of energy needed to charge the battery to a desired state of charge (SOC) at the end of the vacation period. In certain embodiments, the user may input a desired SOC to the controller 16. In other embodiments, the controller 16 may determine the desired SOC based on past behavior. For example, the controller 16 may predict that the user will drive the vehicle 10 to a common destination such as a residence or work location after returning to the vehicle 10 where further charging may be provided.

At action block 550, the method 500 includes determining the most efficient use of energy stored in the battery and energy available from the charger. It is noted that the type of charger, e.g., 120 volt, 240 volt, 480 volt, or other type of charger, that the device 10 is connected to as the outside power source 39, may be considered in the determination.

The sum of estimated thermal energy needed at action block 530 and estimated electrical energy needed at action block 540 is the total estimated energy needed. Action block 550 evaluates the initial SOC, target SOC or SOCs, and desired SOC to reduce thermal inputs, ambient environmental losses, and charge power to determine the most efficient use of energy. As a result, the controller 16 may select a target SOC or target SOCs at which the battery 38 will be maintained during the vacation period.

In certain embodiments, method 500 determines an ideal storage SOC of the battery and an ideal storage battery temperature or temperature range to reduce energy costs and to maintain battery health and expected battery lifetime. In certain embodiments, the ideal storage SOC and an ideal storage battery temperature or temperature range are further selected to reduce wear on other components, such as on components of the thermal management system 12.

In certain embodiments, energy may be discharged from the battery 38 and sold to the electrical grid, and the method may consider energy price movement to optimize the sale and purchase of electricity through the charger during vacation mode.

In certain embodiments, the initial SOC is higher than optimal for thermal management. In such embodiments, the vacation mode may determine that maintaining the battery at a lower SOC is more cost efficient due to reduced thermal management energy costs to maintain the battery at a safe temperature range.

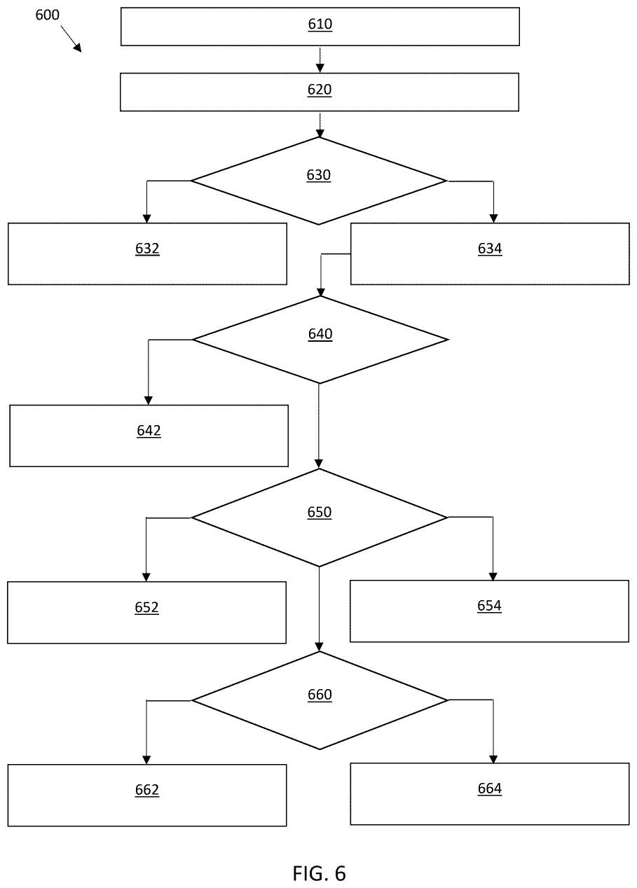

Referring now to FIG. 6, a method 600 for operating a device 10 is illustrated. Method 600 includes, at action block 610, identifying a desired state of charge (SOC) at return time. For example, a user may input directly to the controller 16 the desired SOC and the return time when the device 10 is needed for user. Alternatively, the controller 16 may determine a desired SOC based on historical use. In such an embodiment, the return time may be determined by historical use, or may be determined based on the movement or location of the user at a later time.

Method 600 may include, at action block 620, activating vacation mode of operation. As described above in relation to FIG. 5 and method 500, the controller may determine a target state of charge (SOC) for optimizing use of energy while the device 10 is in an extended state of non-use. For example, the target SOC may be less than 50%, such as less than 40%, less than 20%, or less than 10%, and may be at least 10%, at least 20% at least 30% or at least 40%.

Method 600 continues at inquiry block 630 which queries whether the current SOC is greater than the target SOC.

If the current SOC is greater than the target SOC, then the controller 16 directs the system to consume battery energy for all energy demands at action block 632. For example, the thermal management system 12 may be operated using battery energy. Other sensors and systems of the device 10 are also operated as needed using battery energy.

In certain embodiments, action block 632 may include draining the battery by transferring charge to the outside power source. For example, when possible, battery electricity may be sold to the grid.

Method 600 may run inquiry block 630 continuously. When the current SOC is not greater than the target SOC, then the controller 16 directs the system to consume charger energy, i.e., energy from the outside power source, for all energy demands at action block 634. As result, the battery 38 may be maintained at the target SOC.

Method 600 may continue at inquiry block 640 which queries whether the current SOC is less than the target SOC.

If the current SOC is less than the target SOC, then the controller 16 directs the system to charge the battery with energy from the outside power source. Charging may continue until inquiry block 640 determines that the current SOC is not less than the target SOC.

When query 640 finds that the current SOC is not less than the target SOC, method 600 continues at query 650 which queries whether the battery temperature is within a target range. Specifically, the controller 16 may store in memory 20 a range of battery temperatures for each SOC. Thus, when a target SOC is selected a range of battery temperatures for the battery at the target SOC is known.

When the battery temperature is within the target range, method 600 continues at action block 652 with performing no thermal condition. In other words, the thermal management system 12 is not activated or operation to cool or heat the battery.

Method 600 may continuously run inquiry block 650. When the battery temperature is not within the target range, then the controller 16 directs the thermal management system 12 to condition the battery at action block 654. For example, when the battery temperature is lower than the target range, the thermal management system 12 heats the battery; and when the battery temperature is higher than the target range, the thermal management system 12 cools the battery. The energy source for powering the thermal management system 12 is determined at blocks 630-634 above.

Method 600 further includes, at inquiry block 660, determining whether the return time, i.e., end of non-use period is approaching. For example, the controller 16 may have a pre-determined return time inputted by the user, either at the device 10 or at a location remote from the device 10. Alternatively, the controller 16 may determine a return time based on movement or location of the user, or based on historical behavior. Also, the controller 16 may determine the duration of time needed to charge the battery from the current SOC to the desired SOC based on the properties of the charger and the battery.

When the duration of time until the return time is greater than the necessary charging duration, then inquiry block 660 determines that the return time is not approaching, and the method continues vacation mode operation at action block 662.

When the duration of time until the return time is equal to the necessary charging duration, then inquiry block 660 determines that the return time is approaching, and the method de-activates vacation mode operation at action block 664 and charges the battery to the desired SOC.

In an example, a user drives a vehicle 10 to an airport, and connects to a high power 80A charging station while at an initial SOC of 15%. Ambient temperature is −25° C., and a diurnal temperature range of −25° C. to −15° C. is predicted. The duration of the trip, i.e., non-use of the vehicle, is determined to be 30 days. The algorithm estimates environmental conditions at the end of the trip, and calculates the thermal energy required to maintain the battery in a healthy temperature range. In the example, the battery is charged to the ideal storage SOC, and the target battery temperature is adjusted to ideal storage temperature. When the return time approaches, i.e., in preparation for user return, the controller 16 activates charging of the battery 38 to the customer input desired charge level and to proper battery temperature targets so that the vehicle 10 is ready to drive when the user arrives.

In another example, a user drives vehicle 10 to airport, and connects to high power 80A charging station while at an initial SOC of 15%. Ambient temperature is 34° C., and a diurnal temperature range of 34° C. to 50° C. is predicted. The duration of the trip, i.e., non-use of the vehicle, is determined to be 30 days. The algorithm estimates environmental conditions at the end of the trip, and calculates the thermal energy required to maintain the battery in a healthy temperature range. In the example, the battery is charged to the ideal storage SOC, and the target battery temperature is adjusted to ideal storage temperature. When the return time approaches, i.e., in preparation for user return, the controller 16 activates charging of the battery 38 to the customer input desired charge level and to proper battery temperature targets so that the vehicle 10 is ready to drive when the user arrives.

While each example describes charging a vehicle at an airport, the method and system are also applicable for a user who leaves a vehicle tethered to a charger at a home residence or office location.

It will be appreciated that the systems, vehicles, and methods may vary from those depicted in the Figures and described herein. It will similarly be appreciated that the steps of the methods may differ from that depicted in the Figures, and/or that various steps of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for managing energy for a rechargeable energy storage system (RESS), the method comprising:
identifying a desired state of charge (SOC) of the RESS at a return time;
activating a vacation mode having a target SOC of the RESS and target RESS temperature range, wherein the target SOC is less than the desired SOC;
determining whether a current SOC of the RESS is greater than the target SOC;
when the current SOC is greater than the target SOC, consuming RESS energy for all energy demand;
when the current SOC is less than the target SOC, consuming energy from a charger for all energy demand;
determining whether a temperature of the RESS is outside the target RESS temperature range; and
when the temperature of the RESS is outside the target RESS temperature range, performing a thermal condition process to change the temperature of the RESS to a temperature within the target RESS temperature range.

2. The method of claim 1, further comprising:
calculating a start time necessary to charge the RESS to the desired SOC by the return time;
de-activating the vacation mode at the start time; and
charging the RESS to the desired SOC.

3. The method of claim 1, further comprising receiving an input from a user identifying the desired SOC and the return time.

4. The method of claim 1, further comprising determining the return time based on a location of a user.

5. The method of claim 1, further comprising determining the target SOC and target RESS temperature range of the vacation mode based on predicted ambient conditions.

6. The method of claim 5, further comprising determining a most efficient use of energy stored in the RESS and energy available from the charger.

7. The method of claim 1, further comprising determining the target SOC and target RESS temperature range of the vacation mode based on battery life.

8. The method of claim 1, further comprising transferring RESS energy to the charger when the current SOC is greater than the target SOC.

9. A vehicle comprising:
an electric propulsion system;
a battery; and
a controller operatively connected to the battery, wherein the controller is configured to:
monitor a current battery temperature after the vehicle is connected to an outside power source at a plug time;
determine an outside air temperature;
identify a desired state of charge (SOC) of the battery at a return time;
activate a vacation mode having a target SOC of the battery and target battery temperature range, wherein the target SOC is less than the desired SOC;
determine whether a current SOC of the battery is greater than the target SOC;
when the current SOC is greater than the target SOC, consuming battery energy for all energy demand;
when the current SOC is less than the target SOC, consuming energy from the outside power source for all energy demand;
determine whether a temperature of the battery is outside the target battery temperature range; and
when the temperature of the battery is outside the target battery temperature range, activate a thermal condition process to change the temperature of the battery to a temperature within the target battery temperature range.

10. The vehicle of claim 9, wherein the controller is configured to:
calculate a start time necessary to charge the battery to the desired SOC by the return time;
de-activate the vacation mode at the start time; and
charge the battery to the desired SOC.

11. The vehicle of claim 9, wherein the controller is configured to receive an input from a user identifying the desired SOC and the return time.

12. The vehicle of claim 9, wherein the controller is configured to determine the return time based on a location of a user.

13. The vehicle of claim 12, wherein the controller is configured to receive the location of the user from a mobile device carried by the user.

14. The vehicle of claim 9, wherein the controller is configured to determine the target SOC and target battery temperature range of the vacation mode based on predicted ambient conditions.

15. The vehicle of claim 9, wherein the controller is configured to determine a most efficient use of energy stored in the battery and energy available from the outside power source.

16. The vehicle of claim 9, wherein the controller is configured to determine the target SOC and target battery temperature range of the vacation mode based on battery life.

17. The vehicle of claim 9, wherein the controller is configured to transfer battery energy to the outside power source when the current SOC is greater than the target SOC.

18. A system for managing energy, the system comprising:
a rechargeable energy storage system (RESS); and
a controller operatively connected to the RESS, wherein the controller is configured to:
monitor a current RESS temperature after the system is connected to an outside power source at a plug time;
determine an outside air temperature;
identify a desired state of charge (SOC) of the RESS at a return time;
activate a vacation mode having a target SOC of the RESS and target RESS temperature range, wherein the target SOC is less than the desired SOC;
determine whether a current SOC of the RESS is greater than the target SOC;
when the current SOC is greater than the target SOC, consuming RESS energy for all energy demand;
when the current SOC is less than the target SOC, consuming energy from the outside power source for all energy demand;
determine whether a temperature of the RESS is outside the target RESS temperature range; and
when the temperature of the RESS is outside the target RESS temperature range, activate a thermal condition process to change the temperature of the RESS to a temperature within the target RESS temperature range.

19. The system of claim 18, wherein the controller is configured to:
calculate a start time necessary to charge the RESS to the desired SOC by the return time;
de-activate the vacation mode at the start time; and
charge the RESS to the desired SOC.

20. The system of claim 18, wherein the controller is configured to receive an input from a user identifying the desired SOC and the return time or is configured to determine the return time based on a location of a user.
